(19) United States
(12) Patent Application Publication
(10) Pub. No.: US 2026/0119058 A1
(43) Pub. Date: Apr. 30, 2026

(54) MEMORY CAPACITY ADJUSTMENT METHOD AND APPARATUS, AND SERVER, ELECTRONIC DEVICE AND STORAGE MEDIUM

(71) Applicant: SUZHOU METABRAIN INTELLIGENT TECHNOLOGY CO., LTD., Suzhou, Jiangsu (CN)

(72) Inventors: Xiuqiang SUN, Suzhou, Jiangsu (CN); Baojun LIU, Suzhou, Jiangsu (CN); Jintao GUO, Suzhou, Jiangsu (CN)

(21) Appl. No.: 19/166,825

(22) PCT Filed: May 27, 2024
(86) PCT No.: PCT/CN2024/095403

§ 371 Date: Sep. 18, 2025

(30) Foreign Application Priority Data
Jan. 30, 2024 (CN) 202410129069.8

(51) Int. Cl. G06F 3/06

(52) U.S. Cl. CPC G06F 3/0629; G06F 3/0604; G06F 3/0673

(57) ABSTRACT

The embodiments of the present application relate to the technical field of computer systems and storage. Provided are a memory capacity adjustment method and apparatus, and a server, an electronic device and a storage medium. The method is applied to a server, wherein the server is provided with at least one central processing unit; the central processing unit is provided with a plurality of memory slots; the memory slots are used for allowing memory banks to be installed and connected therein; the plurality of memory slots are connected to a communication protocol interface of a baseboard management controller by means of at least one expansion chip; the plurality of memory slots and the expansion chip have different protocol addresses; and the plurality of memory slots correspond to pins of the expansion chip on a one-to-one basis. The method comprises: reading memory setting information; on the basis of a target protocol address value, determining a target pin of an expansion chip; on the basis of a state setting value, setting a level state of the target pin; and on the basis of the level state of the target pin, setting a slot voltage of a memory slot corresponding to the target pin, wherein the slot voltage is used for adjusting the usage state of a memory bank. By means of the embodiments of the present application, the memory capacity can be dynamically adjusted.

### CROSS-REFERENCE TO RELATED APPLICATION

The present disclosure claims the priority of Chinese patent application filed on Jan. 30, 2024 before the CNIPA, China National Intellectual Property Administration with the application number of 202410129069.8, and the title of “MEMORY CAPACITY ADJUSTMENT METHOD AND APPARATUS, SERVER, ELECTRONIC DEVICE AND STORAGE MEDIUM”, which is incorporated herein in its entirety by reference.

### FIELD

The present disclosure relates to the field of computer system and storage technologies, and in particular to a memory capacity adjustment method, a memory capacity adjustment apparatus, a server, an electronic device and a storage medium.

### BACKGROUND

In a computer system, a memory is a physical device that must exist in any architecture computer product. During an operation of a server, a memory capacity of the memory affects the operation efficiency. Therefore, in order to improve the operation efficiency, a maximized configuration of the memory is commonly used, that is, servers in a data center are all configured to maximize the memory. However, this configuration leads to a waste of the memory, an increase in power consumption, and a decrease in a service life of the memory. Moreover, when errors occur in partial memory, the errors can only be isolated by physical replacement as a whole, and memory banks cannot be isolated dynamically.

### SUMMARY

In view of the above problems, embodiments of the present disclosure are proposed to provide a memory capacity adjustment method, a memory capacity adjustment apparatus, a server, an electronic device and a storage medium that overcome or at least partially solve the above problems.

In order to solve the above problems, in a first aspect of the present disclosure, an embodiment of the present disclosure discloses a memory capacity adjustment method, applied to a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip, and the method includes:
reading memory setting information, where the memory setting information includes a target protocol address value and a state setting value;
determining a target pin of the expansion chip according to the target protocol address value;
setting a level state of the target pin according to the state setting value; and setting a slot voltage of the memory slot corresponding to the target pin according to the level state of the target pin, where the slot voltage is configured to adjust a usage state of the memory bank.

In some embodiments of the present disclosure, the state setting value is a polarized value,
where the polarized value is a high level or a low level.

In some embodiments of the present disclosure, determining the target pin of the expansion chip according to the target protocol address value includes:

determining the target pin of the expansion chip according to a matching result between the target protocol address value and a protocol addresses corresponding to each of the pins of the expansion chip after obtaining the target protocol address value.

In some embodiments of the present disclosure, setting the level state of the target pin according to the state setting value includes:
setting a level of the target pin of the expansion chip to correspond to the state setting value.

In some embodiments of the present disclosure, the level state of the target pin is initially a high level state, and the step of setting the level state of the target pin according to the state setting value includes:
maintaining the level state of the target pin in response to the state setting value being a preset high level setting value; and switching the level state of the target pin in response to the state setting value being a preset low level setting value.

In some embodiments of the present disclosure, the method further includes:
determining a number of used memory banks based on usage states of all memory banks of the whole server, and adjusting the memory capacity.

In some embodiments of the present disclosure, a single slot voltage represents the usage state of the memory bank corresponding to the single slot voltage.

In some embodiments of the present disclosure, setting the slot voltage of the memory slot corresponding to the target pin according to the level state of the target pin includes: synchronously adjusting the slot voltage of the memory slot corresponding to the target pin based on the level state of the target pin to enable the slot voltage of the memory slot corresponding to the target pin to be adjusted to a default state or maintained in the default state.

In some embodiments of the present disclosure, the step of setting the slot voltage of the memory slot corresponding to the target pin according to the level state of the target pin includes:
turning on the slot voltage of the memory slot corresponding to the target pin according to the level state of the target pin to enable the memory bank; and/or
cutting off the slot voltage of the memory slot corresponding to the target pin according to the level state of the target pin to disable the memory bank.

In some embodiments of the present disclosure, a voltage terminal and a ground terminal are provided between the target pin and the memory slot corresponding to the target pin, where the voltage terminal is connected to a preset power supply through a pull-up resistor, and the ground terminal includes a preset power supply ground wire;
the step of turning on the slot voltage of the memory slot corresponding to the target pin according to the level state of the target pin includes:
in response to the level state of the target pin being a high level state, connecting a connection circuit between the target pin and the memory slot corresponding to the target pin to the voltage terminal to enable the connection circuit between the target pin and the memory slot corresponding to the target pin to be connected to the preset power supply and turn on the slot voltage of the memory slot corresponding to the target pin; and
the step of cutting off the slot voltage of the memory slot corresponding to the target pin according to the level state of the target pin includes:
in response to the level state of the target pin being a low level state, connecting the connection circuit between the target pin and the memory slot corresponding to the target pin to the ground terminal to enable the connection circuit between the target pin and the memory slot corresponding to the target pin to be connected to the preset power supply ground wire and cut off the slot voltage of the memory slot corresponding to the target pin.

In some embodiments of the present disclosure, the baseboard management controller controls the memory capacity through a management page or an intelligent platform management interface instruction.

In some embodiments of the present disclosure, the baseboard management controller corresponds to the management page, where the management page includes a state setting control corresponding to the memory bank or the plurality of memory slots, and the step of reading the memory setting information includes:
responding to an setting operation for the state setting control;
determining the target protocol address value from the protocol addresses of the plurality of memory slots according to the setting operation, and determining the state setting value; and
reading the state setting value and the target protocol address value as the memory setting information.

In some embodiments of the present disclosure, the state setting control is an enable or disable control button.

In some embodiments of the present disclosure, the step of reading the memory setting information includes:
reading the intelligent platform management interface instruction from the baseboard management controller;
parsing a target byte of the intelligent platform management interface instruction to determine the state setting value and the target protocol address value; and
reading the state setting value and the target protocol address value as the memory setting information.

In some embodiments of the present disclosure, the method further includes: sending a relevant setting instruction to the baseboard management controller through an intelligent platform management interface in the case where a user needs to control remotely.

In some embodiments of the present disclosure, in the case where the target protocol address value includes a plurality of target protocol address values, the step of determining the target pin of the expansion chip according to the target protocol address value includes:
determining whether the target protocol address value is a last target protocol address value; and
determining the target pin of the expansion chip according to the target protocol address value, and updating the target protocol address value until the target protocol address value is the last target protocol address value in response to the target protocol address value not being the last target protocol address value.

In some embodiments of the present disclosure, the method further includes: performing control operation on the slot voltage of the memory slot is performed in the case where the server is shut down.

In a second aspect of the present disclosure, an embodiment of the present disclosure discloses a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip;
the baseboard management controller reads memory setting information, where the memory setting information includes a target protocol address value and a state setting value;
the baseboard management controller determines a target pin of the expansion chip according to the target protocol address value;
the central processing unit sets a level state of the target pin according to the state setting value; and
the central processing unit sets a slot voltage of the memory slot corresponding to the target pin according to the level state of the target pin, where the slot voltage is configured to adjust a usage state of the memory bank.

In a third aspect of the present disclosure, an embodiment of the present disclosure discloses a memory capacity adjustment apparatus, applied to a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip, and the apparatus includes:
a reading module configured to read memory setting information, where the memory setting information includes a target protocol address value and a state setting value;
a target pin determining module configured to determine a target pin of the expansion chip according to the target protocol address value;
a first setting module configured to set a level state of the target pin according to the state setting value; and
a second setting module configured to control a connection state between the memory slot corresponding to the target pin and the memory bank according to the level state of the target pin to adjust a memory capacity.

In a fourth aspect of the present disclosure, an embodiment of the present disclosure discloses an electronic device, including: a processor, a memory and a computer program stored in the memory and capable of running on the processor, where the computer program, when executed by the processor, cases the processor to implement steps of the above memory capacity adjustment method.

In a fifth aspect of the present disclosure, an embodiment of the present disclosure discloses a computer non-transitory readable storage medium storing a computer program, where the computer program, when executed by a processor, cases the processor to implement steps of the above memory capacity adjustment method.

The embodiments of the present disclosure include following advantages:
in the embodiments of the present disclosure, the central processing unit is provided with a plurality of memory slots, each of the plurality of memory slots is configured to install the memory bank, the plurality of memory slots are connected to the communication protocol interface of the baseboard management controller through at least one expansion chip, the plurality of memory slots and the at least one expansion chip have different protocol addresses, the plurality of memory slots are in the one-to-one correspondence with pins of each of the at least one expansion chip; memory setting information is read, where the memory setting information includes the target protocol address value and the state setting value; the target pin of the expansion chip is determined according to the target protocol address value; the level state of the target pin is set according to the state setting value; and a slot voltage of the memory slot corresponding to the target pin is set according to the level state of the target pin, where the slot voltage is configured to adjust a usage state of the memory bank. By physically connecting the pins of the expansion chip and the voltage of the memory slot in the server, the voltage of the memory slot is controlled by reading level state values of the pins of the expansion chip, and the usage state of the memory bank is further adjusted, so as to control the memory capacity of the server and the power consumption of the whole server.

### BRIEF DESCRIPTION OF THE DRAWINGS

FIG. 1 is a flowchart of steps of an embodiment of a memory capacity adjustment method according to the present disclosure.

FIG. 2 is a flowchart of steps of an embodiment of another memory capacity adjustment method according to the present disclosure.

FIG. 3 is a schematic structural connection diagram of an application server of a memory capacity adjustment method according to the present disclosure.

FIG. 4 is a schematic structural connection diagram of slot voltage turn-on of a memory capacity adjustment method according to the present disclosure.

FIG. 5 is a schematic structural connection diagram of slot voltage cut-off of a memory capacity adjustment method according to the present disclosure.

FIG. 6 is a flowchart of steps of an example of a memory capacity adjustment method according to the present disclosure.

FIG. 7 is a swim lane of an example of a memory capacity adjustment method according to the present disclosure.

FIG. 8 is a swim lane of an example of another memory capacity adjustment method according to the present disclosure.

FIG. 9 is a structural block diagram of an embodiment of a memory capacity adjustment apparatus according to the present disclosure.

FIG. 10 is a structural block diagram of an embodiment of a server according to the present disclosure.

FIG. 11 is a structural block diagram of an electronic device provided in an embodiment of the present disclosure.

FIG. 12 is a structural block diagram of a storage medium provided in an embodiment of the present disclosure.

### DETAILED DESCRIPTION

In order to make the above objectives, features and advantages of the present disclosure more obvious and understandable, the following will provide further detailed explanations of the present disclosure in conjunction with accompanying drawings and specific embodiments.

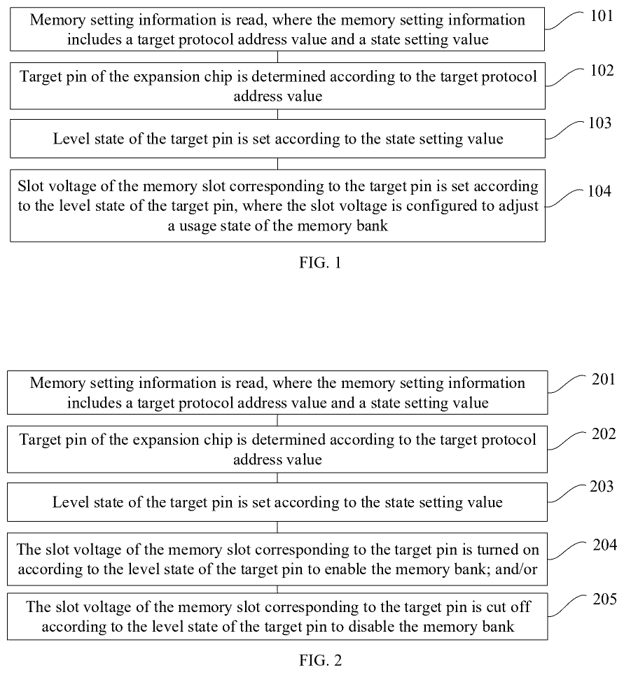

Referring to FIG. 1, FIG. 1 is a flowchart of steps of an embodiment of a memory capacity adjustment method according to the present disclosure. The memory capacity adjustment method is applied to a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip. The memory capacity adjustment method can include following steps.

Step 101, memory setting information is read, where the memory setting information includes a target protocol address value and a state setting value.

In the embodiment of the present disclosure, when it is necessary to adjust the memory capacity, the memory setting information can be read. The memory setting information includes the target protocol address value and the state setting value. The target protocol address value corresponds to one of pins of the expansion chip. The state setting value can be a polarized value, for example, a high level or a low level, which is not limited by the embodiment of the present disclosure.

Step 102, a target pin of the expansion chip is determined according to the target protocol address value.

After obtaining the target protocol address value, the target pin of the expansion chip is first determined according to a matching result between the target protocol address value and a protocol addresses corresponding to each of the pins of the expansion chip.

Step 103, a level state of the target pin is set according to the state setting value.

Then, a level of the target pin of the expansion chip can be set to correspond to the state setting value, thereby realizing the adjustment of the level state of the target pin.

Step 104, a slot voltage of the memory slot corresponding to the target pin is set according to the level state of the target pin, where the slot voltage is configured to adjust a usage state of the memory bank.

The slot voltage of the memory slot corresponding to the target pin can be synchronously adjusted based on the level state of the target pin to enable the slot voltage of the memory slot corresponding to the target pin to be adjusted to a default state or maintained in the default state. A single slot voltage represents the usage state of the memory bank corresponding to the single slot voltage. Therefore, when adjusting the slot voltage of the memory slot, the usage state of the memory bank can be synchronously adjusted; a number of used memory banks can be determined based on usage states of all memory banks of the whole server, and thus the adjustment of the memory capacity may be realized.

In the embodiment of the present disclosure, the central processing unit is provided with a plurality of memory slots, each of the plurality of memory slots is configured to install the memory bank, the plurality of memory slots are connected to the communication protocol interface of the baseboard management controller through at least one expansion chip, the plurality of memory slots and the at least one expansion chip have different protocol addresses, the plurality of memory slots are in the one-to-one correspondence with pins of each of the at least one expansion chip; memory setting information is read, where the memory setting information includes the target protocol address value and the state setting value; the target pin of the expansion chip is determined according to the target protocol address value; the level state of the target pin is set according to the state setting value; and a slot voltage of the memory slot corresponding to the target pin is set according to the level state of the target pin, where the slot voltage is configured to adjust a usage state of the memory bank. By physically connecting the pins of the expansion chip and the voltage of the memory slot in the server, the voltage of the memory slot is controlled by reading level state values of the pins of the expansion chip, and the usage state of the memory bank is further adjusted, so as to control the memory capacity of the server and the power consumption of the whole server.

Referring to FIG. 2, FIG. 2 is a flowchart of steps of an embodiment of another memory capacity adjustment method according to the present disclosure. The memory capacity adjustment method is applied to a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses.

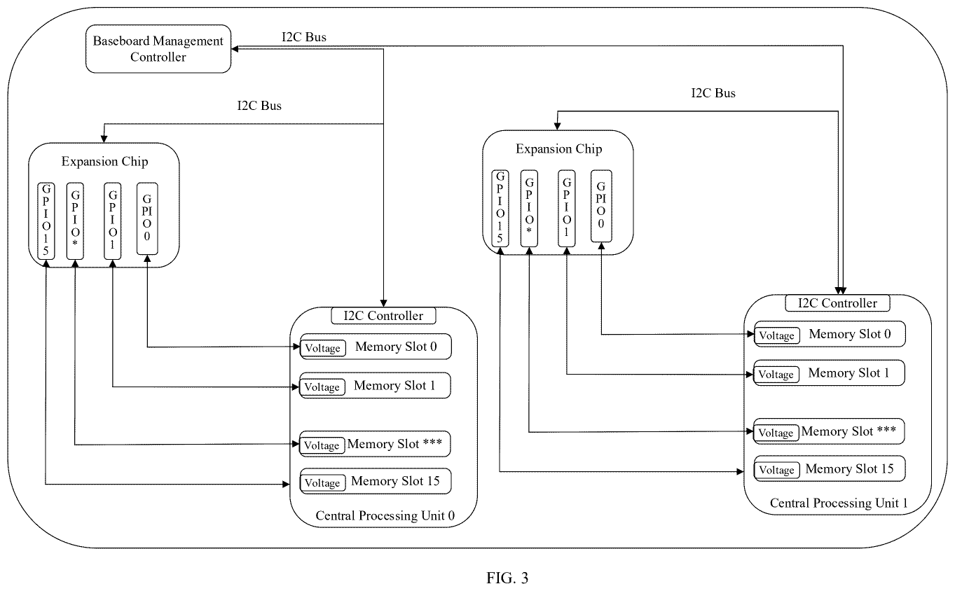

In the embodiment of the present disclosure, the expansion chip can be a plurality of expansion chips, which are determined according to requirements. The number of pins for each of the plurality of expansion chips is also selected according to actual situation. The embodiment of the present disclosure is not limited. The expansion chip can be a general-purpose input/output (GPIO) interface expansion chip. The communication protocol may be an inter-integrated circuit (I2C) protocol. The specific connection relationship can refer to FIG. 3. A server motherboard provides 32 GPIO control pins by introducing two GPIO expansion chips with 16 GPIO pins, and physically connects each of the 32 GPIO control pins to a memory slot of the motherboard, that is, each GPIO control pin is connected to a memory of the memory slot corresponding to the GPIO control pin. An I2C address of the above GPIO expansion chip can be physically linked with an I2C bus of a processor and a unique I2C address can be set. A GPIO expansion chip needs a single I2C address and cannot duplicate the I2C address with other devices. The physical circuit design between the GPIO pin of the GPIO expansion chip and the memory voltage of the memory slot is required, that is, a high level of the GPIO turns on the voltage input, and a low level of the GPIO cuts off the voltage turn-on circuit.

The memory capacity adjustment method can include following steps.

Step 201, memory setting information is read, where the memory setting information includes a target protocol address value and a state setting value.

In the embodiment of the present disclosure, the memory setting information can be read in different ways, and pins that need to be set and the setting state can be determined according to the target protocol address value and the state setting value in the memory setting information.

In some embodiments of the present disclosure, the baseboard management controller corresponds to the management page, where the management page includes a state setting control corresponding to the memory bank or the plurality of memory slots, and the step of reading the memory setting information includes: responding to an setting operation for the state setting control; determining the target protocol address value from the protocol addresses of the plurality of memory slots according to the setting operation, and determining the state setting value; and reading the state setting value and the target protocol address value as the memory setting information.

In the embodiments of the present disclosure, the baseboard management controller will correspond to a management page, and the management page is provided with a state setting control for memory banks or memory slots. For example, the state setting control can be an enable or disable control button.

When a user operates on the state setting control, a setting operation for the state setting control can be responded. The protocol address corresponding to the memory bank or memory slot selected from the protocol addresses of the plurality of memory slots is determined as the target protocol address value according to the memory bank or the memory slot selected by the setting operation. Moreover, the state setting value is determined according to setting contents of the setting operation.

Finally, the memory setting information determined based on the state setting value and the target protocol address value is read to obtain the memory setting information.

In other embodiments of the present disclosure, the step of reading the memory setting information includes: reading the intelligent platform management interface instruction from the baseboard management controller; parsing a target byte of the intelligent platform management interface instruction to determine the state setting value and the target protocol address value; and reading the state setting value and the target protocol address value as the memory setting information.

In the embodiments of the present disclosure, when the user needs to remotely control, a relevant setting instruction can be sent to the baseboard management controller through the intelligent platform management interface. Therefore, the intelligent platform management interface instruction can be read from the baseboard management controller, and parsing is performed for a specific message position in the read intelligent platform management interface instruction. For example, a command format of the intelligent platform management interface instruction is ipmitool raw 0x32 0x71 0x06 0x00 0x01, where parsing can be performed for last two bytes. 0x00 represents a first GPIO of a first GPIO expansion chip, 0x01 represents that it is set to a high state, that is, the memory voltage is turned on, and if it is 0x0, it means that the memory voltage turn-on function is turned off; 0x10 represents a first GPIO of a second GPIO expansion chip, 0x01 represents that it is set to a high state, that is, the memory voltage is turned on, and if it is 0x0, it means that the memory voltage turn-on function is turned off. The state setting value and the target protocol address value are determined according to parsed message contents; and the state setting value and the target protocol address value are read as the memory setting information.

Step 202, a target pin of the expansion chip is determined according to the target protocol address value.

A pin of the expansion chip corresponding to the target protocol address value is queried according to the target protocol address value, and the pin is the target pin of the expansion chip.

In some embodiments of the present disclosure, in the case where the target protocol address value includes a plurality of target protocol address values, the step of determining the target pin of the expansion chip according to the target protocol address value includes: determining whether the target protocol address value is a last target protocol address value; and determining the target pin of the expansion chip according to the target protocol address value, and updating the target protocol address value until the target protocol address value is the last target protocol address value in response to the target protocol address value not being the last target protocol address value.

In addition, when the target protocol address values are multiple, it is necessary to set a plurality of memory banks simultaneously. At this time, it is possible to determine whether the target protocol address value is the last target protocol address value. When the target protocol address value is not the last target protocol address value, the step of determining the target pin of the expansion chip according to the target protocol address value can be performed first to determine the target pin of the expansion chip corresponding to the current target protocol address value. Then, the next target protocol address value is updated, and a target pin of a new expansion chip is determined based on the updated target protocol address value, and so on, until the target pin of the expansion chip corresponding to the last target protocol address value is also determined; and all target pins of the expansion chip are taken as the target pins of the expansion chip to be processed.

Step 203, a level state of the target pin is set according to the state setting value.

The level state of the target pin can be set according to the state setting value, so that the level state of the target pin is consistent with the state setting value. If the state setting value is a high level, the level state of the target pin is set to the high level.

In some embodiments of the present disclosure, the level state of the target pin is initially a high level state, and the step of setting the level state of the target pin according to the state setting value includes: maintaining the level state of the target pin in response to the state setting value being a preset high level setting value; and switching the level state of the target pin in response to the state setting value being a preset low level setting value.

In the embodiments of the present disclosure, the level state of the target pin is initially the high level state, that is, it is the high level state by default. When the state setting value is the preset high level setting value, the level state of the target pin can be maintained in response to the state setting value being the preset high level setting value, so that the level state of the target pin can be maintained in the high level state. When the state setting value is the preset low level setting value, the level state of the target pin can be switched in response to the state setting value being the preset low level setting value, and the high level state of the target pin can be switched to a low level state, so that the level state of the target pin is a low level state.

Step 204, the slot voltage of the memory slot corresponding to the target pin is turned on according to the level state of the target pin to enable the memory bank.

Step 205, the slot voltage of the memory slot corresponding to the target pin is cut off according to the level state of the target pin to disable the memory bank.

In the embodiments of the present disclosure, the slot voltage of the memory slot corresponding to the target pin can be turned on according to the level state of the target pin, so that the slot voltage of the memory slot is set to a high level, thereby enabling the memory bank to be used for business processing, that is, increasing the memory capacity. And/or, the slot voltage of the memory slot corresponding to the target pin can be cut off according to the level state of the target pin, so that the slot voltage of the memory slot is set to a low level, then the memory bank is turned off, and the memory bank is not used as an available memory for business processing, that is, reducing the memory capacity. By setting the corresponding voltage of the memory slot, isolation may be realized, and it is not necessary to dismantle and replace the whole memory slot, which may improve the operation and maintenance efficiency.

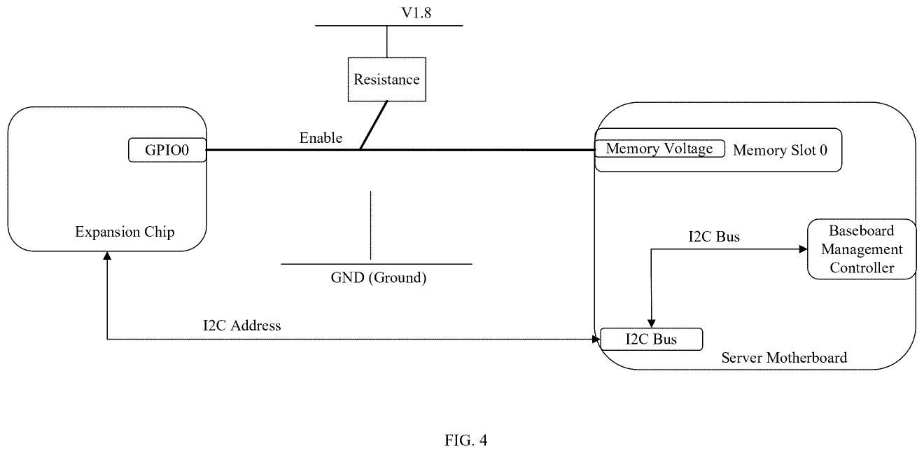

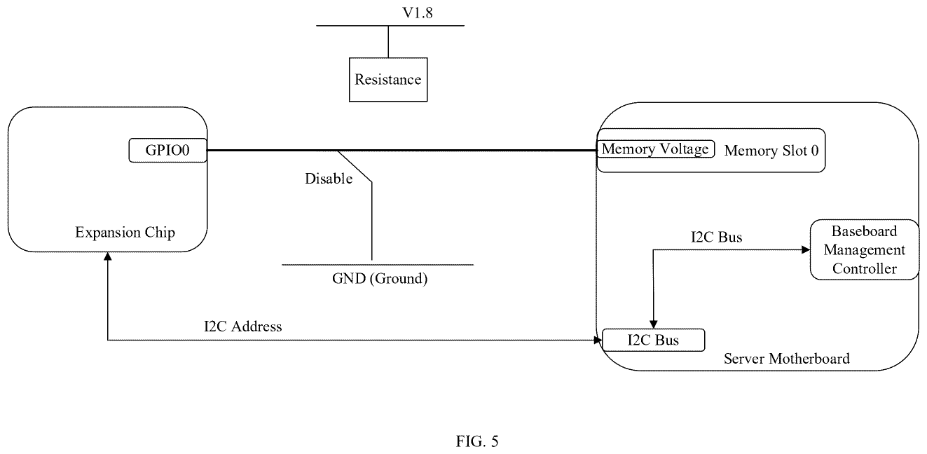

In some embodiments of the present disclosure, referring to FIG. 4 and FIG. 5, a voltage terminal and a ground terminal are provided between the target pin and the memory slot corresponding to the target pin, where the voltage terminal is connected to a preset power supply through a pull-up resistor, and the ground terminal includes a preset power supply ground wire;
the step of turning on the slot voltage of the memory slot corresponding to the target pin according to the level state of the target pin includes:
in response to the level state of the target pin being a high level state, connecting a connection circuit between the target pin and the memory slot corresponding to the target pin to the voltage terminal to enable the connection circuit between the target pin and the memory slot corresponding to the target pin to be connected to the preset power supply and turn on the slot voltage of the memory slot corresponding to the target pin; and
the step of cutting off the slot voltage of the memory slot corresponding to the target pin according to the level state of the target pin includes:
in response to the level state of the target pin being a low level state, connecting the connection circuit between the target pin and the memory slot corresponding to the target pin to the ground terminal to enable the connection circuit between the target pin and the memory slot corresponding to the target pin to be connected to the preset power supply ground wire and cut off the slot voltage of the memory slot corresponding to the target pin.

Referring to FIG. 4, in response to the level state of the target pin being the high level state, the connection circuit between the target pin and the memory slot corresponding to the target pin is connected to the voltage terminal. At this time, the connection circuit between the target pin and the memory slot corresponding to the target pin is connected to the preset power supply, the voltage of the memory slot is the high level, and the slot voltage of the memory slot corresponding to the target pin is turned on.

Referring to FIG. 5, in response to the level state of the target pin being the low level state, the connection circuit between the target pin and the memory slot corresponding to the target pin is connected to the ground terminal. At this time, the connection circuit between the target pin and the memory slot corresponding to the target pin is connected to the preset power supply ground wire, the voltage of the memory slot is the low level, and the slot voltage of the memory slot corresponding to the target pin is cut off.

In the embodiments of the present disclosure, the central processing unit is provided with a plurality of memory slots, each of the plurality of memory slots is configured to install the memory bank, the plurality of memory slots are connected to the communication protocol interface of the baseboard management controller through at least one expansion chip, the plurality of memory slots and the at least one expansion chip have different protocol addresses, the plurality of memory slots are in the one-to-one correspondence with pins of each of the at least one expansion chip; memory setting information is read, where the memory setting information includes the target protocol address value and the state setting value; the target pin of the expansion chip is determined according to the target protocol address value; the level state of the target pin is set according to the state setting value; the slot voltage of the memory slot corresponding to the target pin is turned on according to the level state of the target pin to enable the memory bank; and/or the slot voltage of the memory slot corresponding to the target pin is cut off according to the level state of the target pin to disable the memory bank. By physically connecting the pins of the expansion chip and the voltage of the memory slot in the server, the voltage of the memory slot is controlled by reading level state values of the pins of the expansion chip, and the usage state of the memory bank is further adjusted, so as to control the memory capacity of the server and the power consumption of the whole server. Moreover, when the memory bank needs to be isolated, it can be isolated by setting the corresponding voltage of the memory slot, and it is not necessary to dismantle and replace the whole memory slot, which may improve the operation and maintenance efficiency. In addition, faulty memory banks may be isolated to avoid causing greater server errors, thereby improving the operation efficiency.

In order to make a person skilled in the art more aware of the implementation process of the embodiments of the present disclosure, following examples are used to illustrate.

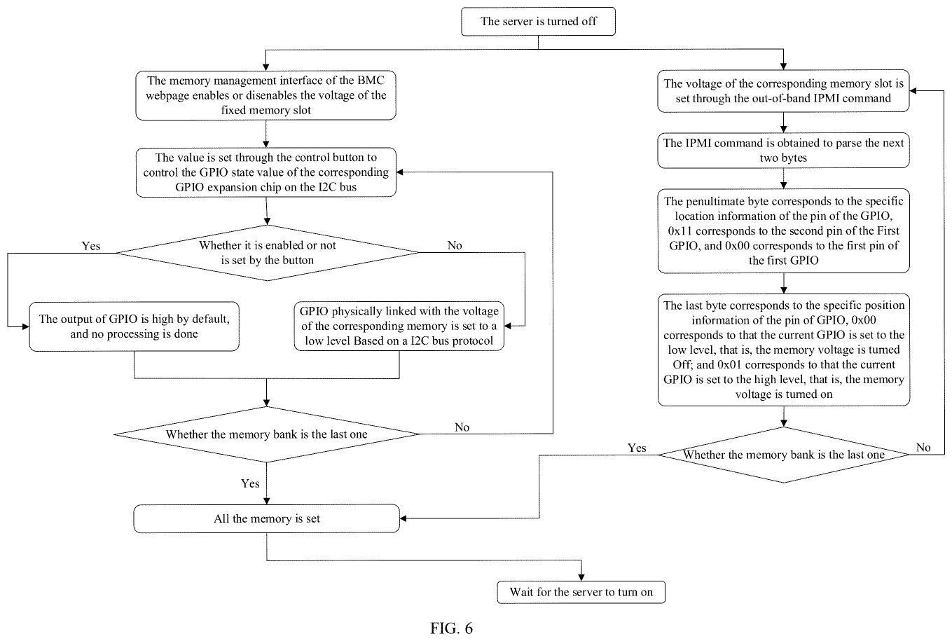

Referring to FIG. 6, FIG. 6 is a flowchart of steps of an embodiment of a memory capacity adjustment method according to the present disclosure.

The voltage control of the memory needs to be operated when the server is turned off. If the server is turned on, there will be a risk of data loss or uncontrollability. This is because after the server is turned on, all data will run in the memory of the server, if there is a problem in the memory, it will be impossible to predict server failure.

After the server is turned off, the level of the corresponding target pin of the expansion chip that needs to be controlled can be determined according to operations of the user on a management webpage of the baseboard management controller or an intelligent platform management interface (IPMI) command, and then, the voltage of the corresponding memory slot can be controlled according to the level of the target pin, so as to control whether the memory bank is enabled, thereby realizing the control of the memory capacity.

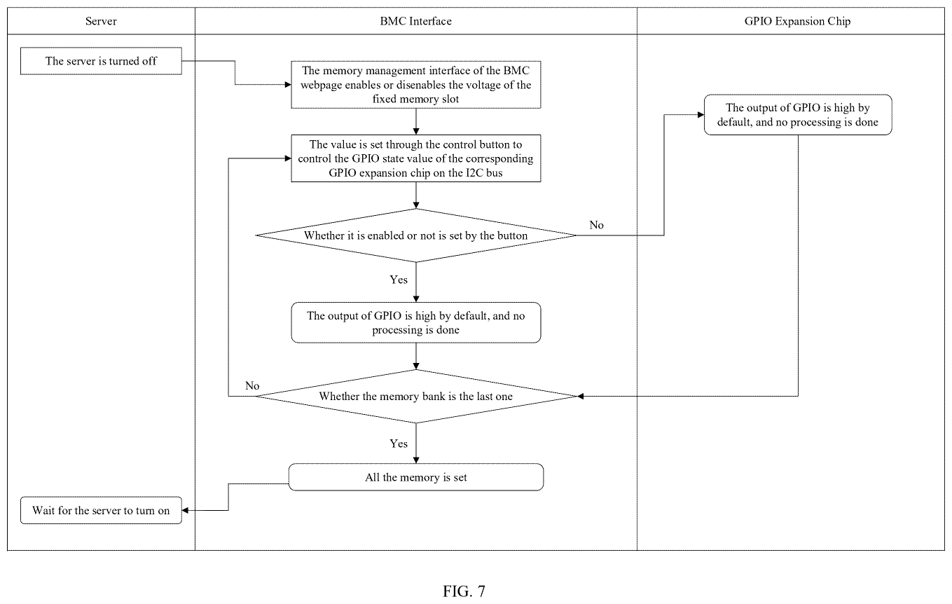

The control process of the management webpage of the baseboard management controller can refer to FIG. 7. The baseboard management controller (BMC) webpage adds enable or disable control buttons of memory banks or memory slots in the memory management interface. The control buttons set the state value of the GPIO signal physical linked with the voltage of the memory slot to a high or low state through interface functions and based on the I2C protocol, so as to enable or disable the memory of the memory slot.

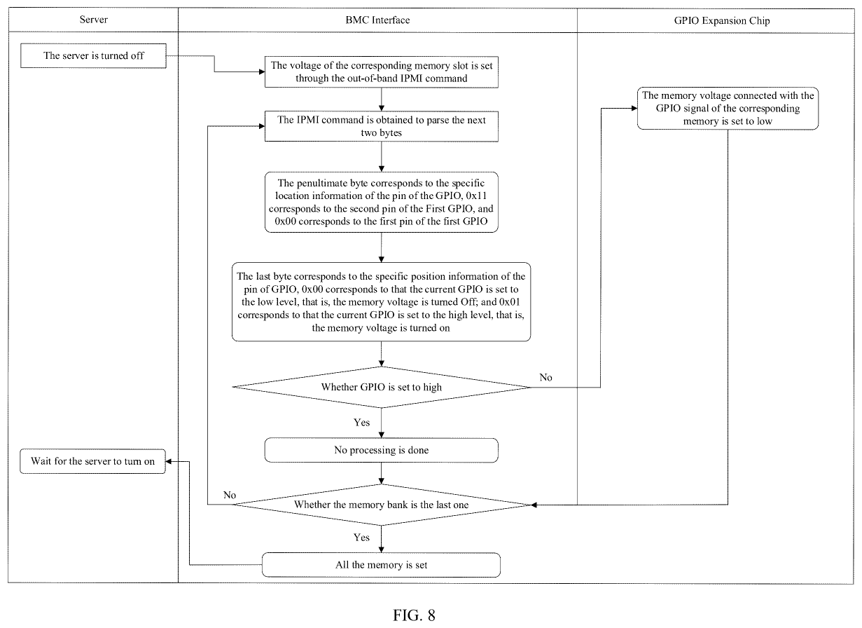

The control process of the IPMI command of the baseboard management controller can refer to FIG. 8. The IPMI command on the BMC can remotely control the memory voltage of the memory slot of the server motherboard out of band. The format of the command is ipmitool raw 0x32 0x71 0x06 0x00 0x01, where for last two bytes, 0x00 represents a first GPIO of a first GPIO expansion chip, 0x01 represents that it is set to a high state, that is, the memory voltage is turned on, and if it is 0x0, it means that the memory voltage turn-on function is turned off; 0x10 represents a first GPIO of a second GPIO expansion chip, 0x01 represents that it is set to a high state, that is, the memory voltage is turned on, and if it is 0x0, it means that the memory voltage turn-on function is turned off; and the 16th GPIO signal can be represented by 0x0F.

The memory is controlled by one of the above two methods, so as to adjust the memory capacity.

It should be noted that for the sake of simplicity, the method embodiments are described as a series of action combinations. However, a person skilled in the art should be aware that some embodiments of the present disclosure are not limited by the order of the actions described, as some steps may be performed in other orders or simultaneously according to some embodiments of the present disclosure. Secondly, a person skilled in the art should also be aware that some embodiments described in the specification belong to the embodiments of the present disclosure, and the actions involved are not necessarily necessary for some embodiments of the present disclosure.

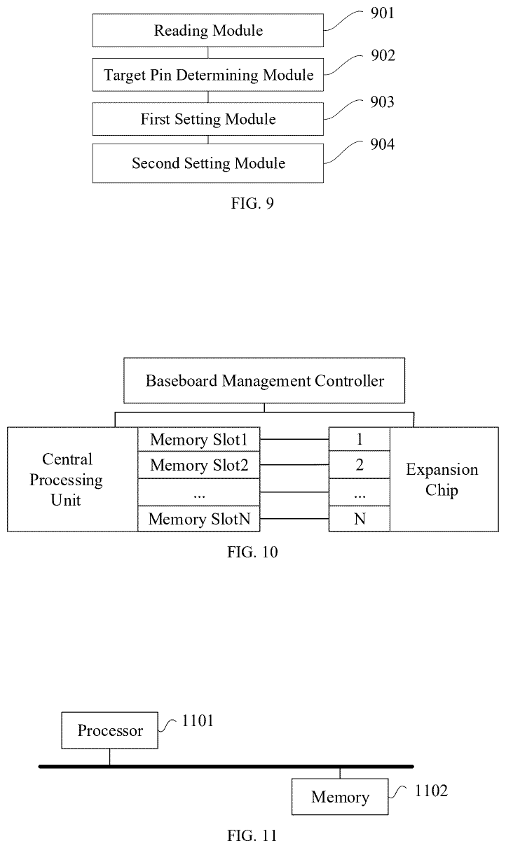

Referring to FIG. 9, FIG. 9 is a structural block diagram of an embodiment of a memory capacity adjustment apparatus according to the present disclosure. The memory capacity adjustment apparatus is applied to a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip. The memory capacity adjustment apparatus can include following modules:
a reading module 901 configured to read memory setting information, where the memory setting information includes a target protocol address value and a state setting value;
a target pin determining module 902 configured to determine a target pin of the expansion chip according to the target protocol address value;
a first setting module 903 configured to set a level state of the target pin according to the state setting value; and
a second setting module 904 configured to control a connection state between the memory slot corresponding to the target pin and the memory bank according to the level state of the target pin to adjust a memory capacity.

In some embodiments of the present disclosure, the second setting module 904 includes:
a turn-on setting submodule configured to turn on the slot voltage of the memory slot corresponding to the target pin according to the level state of the target pin to enable the memory bank; and/or
a cut-off setting submodule configured to cut off the slot voltage of the memory slot corresponding to the target pin according to the level state of the target pin to disable the memory bank.

In some embodiments of the present disclosure, a voltage terminal and a ground terminal are provided between the target pin and the memory slot corresponding to the target pin, where the voltage terminal is connected to a preset power supply through a pull-up resistor, and the ground terminal includes a preset power supply ground wire;
the turn-on setting submodule includes:
a first response unit configured to in response to the level state of the target pin being a high level state, connect a connection circuit between the target pin and the memory slot corresponding to the target pin to the voltage terminal to enable the connection circuit between the target pin and the memory slot corresponding to the target pin to be connected to the preset power supply and turn on the slot voltage of the memory slot corresponding to the target pin; and
correspondingly, the cut-off setting submodule includes:
a second response unit configured to in response to the level state of the target pin being a low level state, connect the connection circuit between the target pin and the memory slot corresponding to the target pin to the ground terminal to enable the connection circuit between the target pin and the memory slot corresponding to the target pin to be connected to the preset power supply ground wire and cut off the slot voltage of the memory slot corresponding to the target pin.

In some embodiments of the present disclosure, the baseboard management controller corresponds to the management page, where the management page includes a state setting control corresponding to the memory bank or the plurality of memory slots, and the reading module 901 includes:
a second response submodule configured to respond to an setting operation for the state setting control;
a setting operation determining submodule configured to determine the target protocol address value from the protocol addresses of the plurality of memory slots according to the setting operation, and determining the state setting value; and
a first reading submodule configured to read the state setting value and the target protocol address value as the memory setting information.

In some embodiments of the present disclosure, the level state of the target pin is initially a high level state, and the first setting module 903 includes:
a third response submodule configured to maintain the level state of the target pin in response to the state setting value being a preset high level setting value; and
a fourth response submodule configured to switch the level state of the target pin in response to the state setting value being a preset low level setting value.

In some embodiments of the present disclosure, the reading module 901 includes:
a second reading submodule configured to read the intelligent platform management interface instruction from the baseboard management controller;
a parsing submodule configured to parse a target byte of the intelligent platform management interface instruction to determine the state setting value and the target protocol address value; and
a third reading submodule configured to read the state setting value and the target protocol address value as the memory setting information.

In some embodiments of the present disclosure, in the case where the target protocol address value includes a plurality of target protocol address values, the target pin determining module 902 includes:
a determining submodule configured to determine whether the target protocol address value is a last target protocol address value; and
a fifth response submodule configured to in response to the target protocol address value not being the last target protocol address value, determine the target pin of the expansion chip according to the target protocol address value, and update the target protocol address value until the target protocol address value is the last target protocol address value.

The apparatus embodiments are substantially similar to the method embodiments, and thus the description is relatively simple, and the relevant points can be found in part of the description of the method embodiments.

Referring to FIG. 10, an embodiment of the present disclosure further provides a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip;
the baseboard management controller reads memory setting information, where the memory setting information includes a target protocol address value and a state setting value;
the baseboard management controller determines a target pin of the expansion chip according to the target protocol address value;
the central processing unit sets a level state of the target pin according to the state setting value; and
the central processing unit sets a slot voltage of the memory slot corresponding to the target pin according to the level state of the target pin, where the slot voltage is configured to adjust a usage state of the memory bank.

In some embodiments of the present disclosure, the step of setting, by the central processing unit, the slot voltage of the memory slot corresponding to the target pin according to the level state of the target pin includes:
turning, by the central processing unit, on the slot voltage of the memory slot corresponding to the target pin according to the level state of the target pin to enable the memory bank; and/or
cutting, by the central processing unit, off the slot voltage of the memory slot corresponding to the target pin according to the level state of the target pin to disable the memory bank.

In some embodiments of the present disclosure, a voltage terminal and a ground terminal are provided between the target pin and the memory slot corresponding to the target pin, where the voltage terminal is connected to a preset power supply through a pull-up resistor, and the ground terminal includes a preset power supply ground wire;
the step of turning, by the central processing unit, on the slot voltage of the memory slot corresponding to the target pin according to the level state of the target pin includes:
in response to the level state of the target pin being a high level state, connecting, by the central processing unit, a connection circuit between the target pin and the memory slot corresponding to the target pin to the voltage terminal to enable the connection circuit between the target pin and the memory slot corresponding to the target pin to be connected to the preset power supply and turn on the slot voltage of the memory slot corresponding to the target pin; and
correspondingly, the step of cutting, by the central processing unit, off the slot voltage of the memory slot corresponding to the target pin according to the level state of the target pin includes:
in response to the level state of the target pin being a low level state, connecting, by the central processing unit, the connection circuit between the target pin and the memory slot corresponding to the target pin to the ground terminal to enable the connection circuit between the target pin and the memory slot corresponding to the target pin to be connected to the preset power supply ground wire and cut off the slot voltage of the memory slot corresponding to the target pin.

In some embodiments of the present disclosure, the baseboard management controller corresponds to the management page, where the management page includes a state setting control corresponding to the memory bank or the plurality of memory slots, and the step of reading, by the baseboard management controller, the memory setting information includes:
responding, by the baseboard management controller, to an setting operation for the state setting control;
determining, by the baseboard management controller, the target protocol address value from the protocol addresses of the plurality of memory slots according to the setting operation, and determining the state setting value; and
reading, by the baseboard management controller, the state setting value and the target protocol address value as the memory setting information.

In some embodiments of the present disclosure, the step of reading, by the baseboard management controller, the memory setting information includes:
reading, by the baseboard management controller, the intelligent platform management interface instruction from the baseboard management controller;
parsing, by the baseboard management controller, a target byte of the intelligent platform management interface instruction to determine the state setting value and the target protocol address value; and
reading, by the baseboard management controller, the state setting value and the target protocol address value as the memory setting information.

In some embodiments of the present disclosure, the level state of the target pin is initially a high level state, and the step of setting, by central processing unit, the level state of the target pin according to the state setting value includes:
maintaining, by central processing unit, the level state of the target pin in response to the state setting value being a preset high level setting value; and
switching, by central processing unit, the level state of the target pin in response to the state setting value being a preset low level setting value.

In some embodiments of the present disclosure, in the case where the target protocol address value includes a plurality of target protocol address values, the step of determining, by the baseboard management controller, the target pin of the expansion chip according to the target protocol address value includes:
determining, by the baseboard management controller, whether the target protocol address value is a last target protocol address value; and
determining, by the baseboard management controller, the target pin of the expansion chip according to the target protocol address value, and updating the target protocol address value until the target protocol address value is the last target protocol address value in response to the target protocol address value not being the last target protocol address value.

Referring to FIG. 11, an embodiment of the present disclosure further provides an electronic device, including:
a processor 1101 and a memory 1102, where the memory 1102 stores a computer program executable by the processor 1101, and when the electronic device is running, the processor 1101 executes the computer program to perform the memory capacity adjustment method described in any one of the embodiments of the present disclosure.

The memory capacity adjustment method is applied to a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip, and the method includes:
reading memory setting information, where the memory setting information includes a target protocol address value and a state setting value;
determining a target pin of the expansion chip according to the target protocol address value;
setting a level state of the target pin according to the state setting value; and
setting a slot voltage of the memory slot corresponding to the target pin according to the level state of the target pin, where the slot voltage is configured to adjust a usage state of the memory bank.

In some embodiments of the present disclosure, the step of setting the slot voltage of the memory slot corresponding to the target pin according to the level state of the target pin includes:
turning on the slot voltage of the memory slot corresponding to the target pin according to the level state of the target pin to enable the memory bank; and/or
cutting off the slot voltage of the memory slot corresponding to the target pin according to the level state of the target pin to disable the memory bank.

In some embodiments of the present disclosure, a voltage terminal and a ground terminal are provided between the target pin and the memory slot corresponding to the target pin, where the voltage terminal is connected to a preset power supply through a pull-up resistor, and the ground terminal includes a preset power supply ground wire;
the step of turning on the slot voltage of the memory slot corresponding to the target pin according to the level state of the target pin includes:
in response to the level state of the target pin being a high level state, connecting a connection circuit between the target pin and the memory slot corresponding to the target pin to the voltage terminal to enable the connection circuit between the target pin and the memory slot corresponding to the target pin to be connected to the preset power supply and turn on the slot voltage of the memory slot corresponding to the target pin; and
the step of cutting off the slot voltage of the memory slot corresponding to the target pin according to the level state of the target pin includes:
in response to the level state of the target pin being a low level state, connecting the connection circuit between the target pin and the memory slot corresponding to the target pin to the ground terminal to enable the connection circuit between the target pin and the memory slot corresponding to the target pin to be connected to the preset power supply ground wire and cut off the slot voltage of the memory slot corresponding to the target pin.

In some embodiments of the present disclosure, the baseboard management controller corresponds to the management page, where the management page includes a state setting control corresponding to the memory bank or the plurality of memory slots, and the step of reading the memory setting information includes:
responding to an setting operation for the state setting control;
determining the target protocol address value from the protocol addresses of the plurality of memory slots according to the setting operation, and determining the state setting value; and
reading the state setting value and the target protocol address value as the memory setting information.

In some embodiments of the present disclosure, the level state of the target pin is initially a high level state, and the step of setting the level state of the target pin according to the state setting value includes:
maintaining the level state of the target pin in response to the state setting value being a preset high level setting value; and
switching the level state of the target pin in response to the state setting value being a preset low level setting value.

In some embodiments of the present disclosure, the step of reading the memory setting information includes:
reading the intelligent platform management interface instruction from the baseboard management controller;
parsing a target byte of the intelligent platform management interface instruction to determine the state setting value and the target protocol address value; and
reading the state setting value and the target protocol address value as the memory setting information.

In some embodiments of the present disclosure, in the case where the target protocol address value includes a plurality of target protocol address values, the step of determining the target pin of the expansion chip according to the target protocol address value includes:
determining whether the target protocol address value is a last target protocol address value; and
determining the target pin of the expansion chip according to the target protocol address value, and updating the target protocol address value until the target protocol address value is the last target protocol address value in response to the target protocol address value not being the last target protocol address value.

The memory can include random access memory (RAM) or non-volatile memory, for example, at least one disk memory. Alternatively, the memory can also be at least one storage apparatus located away from the aforementioned processor.

The above processor can be a general purpose processor, including a central processing unit (CPU), a network processor (NP), and the like, or can also be a digital signal processing (DSP), an application specific integrated circuit (ASIC), a field-programmable gate array (FPGA) or other programmable logic devices, discrete gate or transistor logic devices, and discrete hardware components.

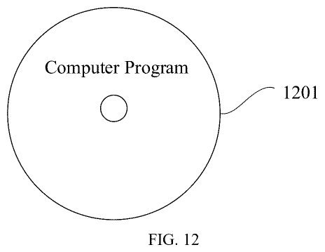

Referring to FIG. 12, an embodiment of the present disclosure further provides a computer non-transitory readable storage medium 1201 storing a computer program, where the computer program, when executed by a processor, cases the processor to perform the memory capacity adjustment method described in any one of the embodiments of the present disclosure.

The memory capacity adjustment method is applied to a server, where the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip, and the method includes:
reading memory setting information, where the memory setting information includes a target protocol address value and a state setting value;
determining a target pin of the expansion chip according to the target protocol address value;
setting a level state of the target pin according to the state setting value; and
setting a slot voltage of the memory slot corresponding to the target pin according to the level state of the target pin, where the slot voltage is configured to adjust a usage state of the memory bank.

In some embodiments of the present disclosure, the step of setting the slot voltage of the memory slot corresponding to the target pin according to the level state of the target pin includes:
turning on the slot voltage of the memory slot corresponding to the target pin according to the level state of the target pin to enable the memory bank; and/or
cutting off the slot voltage of the memory slot corresponding to the target pin according to the level state of the target pin to disable the memory bank.

In some embodiments of the present disclosure, a voltage terminal and a ground terminal are provided between the target pin and the memory slot corresponding to the target pin, where the voltage terminal is connected to a preset power supply through a pull-up resistor, and the ground terminal includes a preset power supply ground wire;
the step of turning on the slot voltage of the memory slot corresponding to the target pin according to the level state of the target pin includes:
in response to the level state of the target pin being a high level state, connecting a connection circuit between the target pin and the memory slot corresponding to the target pin to the voltage terminal to enable the connection circuit between the target pin and the memory slot corresponding to the target pin to be connected to the preset power supply and turn on the slot voltage of the memory slot corresponding to the target pin; and
the step of cutting off the slot voltage of the memory slot corresponding to the target pin according to the level state of the target pin includes:
in response to the level state of the target pin being a low level state, connecting the connection circuit between the target pin and the memory slot corresponding to the target pin to the ground terminal to enable the connection circuit between the target pin and the memory slot corresponding to the target pin to be connected to the preset power supply ground wire and cut off the slot voltage of the memory slot corresponding to the target pin.

In some embodiments of the present disclosure, the baseboard management controller corresponds to the management page, where the management page includes a state setting control corresponding to the memory bank or the plurality of memory slots, and the step of reading the memory setting information includes:
responding to an setting operation for the state setting control;
determining the target protocol address value from the protocol addresses of the plurality of memory slots according to the setting operation, and determining the state setting value; and
reading the state setting value and the target protocol address value as the memory setting information.

In some embodiments of the present disclosure, the level state of the target pin is initially a high level state, and the step of setting the level state of the target pin according to the state setting value includes:
maintaining the level state of the target pin in response to the state setting value being a preset high level setting value; and
switching the level state of the target pin in response to the state setting value being a preset low level setting value.

In some embodiments of the present disclosure, the step of reading the memory setting information includes:
reading the intelligent platform management interface instruction from the baseboard management controller;
parsing a target byte of the intelligent platform management interface instruction to determine the state setting value and the target protocol address value; and
reading the state setting value and the target protocol address value as the memory setting information.

In some embodiments of the present disclosure, in the case where the target protocol address value includes a plurality of target protocol address values, the step of determining the target pin of the expansion chip according to the target protocol address value includes:
determining whether the target protocol address value is a last target protocol address value; and
determining the target pin of the expansion chip according to the target protocol address value, and updating the target protocol address value until the target protocol address value is the last target protocol address value in response to the target protocol address value not being the last target protocol address value.

The various embodiments in the present disclosure are described in a progressive manner. Some embodiments focus on differences from other embodiments. The same or similar parts between the various embodiments can be referred to each other.

A person skilled in the art should understand that some embodiments of the present disclosure can be provided as methods, apparatus, or computer program products. Therefore, some embodiments of the present disclosure can take the form of an entirely hardware embodiment, an entirely software embodiment, or an embodiment combining software and hardware. Moreover, some embodiments of the present disclosure can take the form of a computer program product embodied on one or more computer usable storage medium (including but not limited to disk storage, CD-ROM, optical storage, and the like) containing computer usable program codes.

Some embodiments of the present disclosure are described with reference to flowcharts and/or block diagrams of methods, terminal devices (systems), and computer program products according to some embodiments of the present disclosure. It should be understood that each flow and/or block of the flowcharts and/or block diagrams and a combination of flows and/or blocks of the flowcharts and/or block diagrams can be implemented by computer program instructions. These computer program instructions can be provided to a processor of a general purpose computer, a special purpose computer, an embedded processor, or other programmable data processing terminal devices to produce a machine, so that instructions are executed by the processor of the computer or other programmable data processing terminal devices to produce means for implementing the functions specified in one or more flows in the flowchart and/or one or more blocks in the block diagram.

These computer program instructions can also be stored in a computer readable memory that can direct a computer or other programmable data processing terminal devices to operate in a particular manner, so that the instructions stored in the computer readable memory produce a manufacture that includes instruction apparatuses. The instruction apparatuses implement the functions specified in one or more flows in the flowchart and/or one or more blocks in the block diagram.

These computer program instructions can also be loaded onto a computer or other programmable data processing terminal devices, so that a series of operational steps are performed on the computer or other programmable terminal devices to produce computer implemented processing. The instructions executed on the computer or other programmable terminal devices provide steps for implementing the functions specified in one or more flows in the flowchart and/or one or more blocks in the block diagram.

Although some embodiments of the present disclosure have been described, a person skilled in the art can make additional changes and modifications to these embodiments once they are aware of the basic inventive concept. Therefore, the appended claims are intended to be interpreted as including the embodiments and all changes and modifications that fall within the scope of some embodiments of the present disclosure.

Finally, it should also be noted that in the present disclosure, relational terms such as “first” and “second” are only used to distinguish one entity or operation from another entity or operation, and do not necessarily require or imply any such actual relationship or order between these entities or operations. Moreover, the terms “comprises”, “comprising” or any other variations are intended to encompass a non-exclusive inclusion, so that processes, methods, articles, or terminal devices that include a plurality of elements include not only those elements but also other elements that are not explicitly listed, or elements inherent to such processes, methods, articles, or terminal devices. Without further limitation, an element defined by the phrase “comprising a.” does not exclude the presence of additional identical elements in the processes, methods, articles, or terminal devices that include the element.

The memory capacity adjustment method, the memory capacity adjustment apparatus, the server, the electronic device and the storage medium provided by the present disclosure are described in detail as above. The principles and embodiments of the present disclosure are described with the specific examples. The descriptions of the above some embodiments are only for helping to understand the method and core ideas of the present disclosure. At the same time, for a person of ordinary skill in the art, according to the ideas of the present disclosure, there may be changes in specific embodiments and application scopes. In summary, contents of the specification should not be understood as limiting the present disclosure.

1. A memory capacity adjustment method, applied to a server, wherein the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip, and the method comprises:
reading memory setting information, wherein the memory setting information comprises a target protocol address value and a state setting value;
determining a target pin of the expansion chip according to the target protocol address value;
setting a level state of the target pin according to the state setting value; and
setting a slot voltage of the memory slot corresponding to the target pin according to the level state of the target pin, wherein the slot voltage is configured to adjust a usage state of the memory bank.

2. The method according to claim 1, wherein
the state setting value is a polarized value,
wherein the polarized value is a high level or a low level.

3. The method according to claim 1, wherein determining the target pin of the expansion chip according to the target protocol address value comprises:
determining the target pin of the expansion chip according to a matching result between the target protocol address value and a protocol addresses corresponding to each of the pins of the expansion chip after obtaining the target protocol address value.

4. The method according to claim 1, wherein setting the level state of the target pin according to the state setting value comprises:
setting a level of the target pin of the expansion chip to correspond to the state setting value.

5. The method according to claim 4, wherein the level state of the target pin is initially a high level state, and the step of setting the level state of the target pin according to the state setting value comprises:
maintaining the level state of the target pin in response to the state setting value being a preset high level setting value; and
switching the level state of the target pin in response to the state setting value being a preset low level setting value.

6. The method according to claim 1, wherein the method further comprises:
determining a number of used memory banks based on usage states of all memory banks of the whole server, and adjusting the memory capacity.

7. The method according to claim 1, wherein
a single slot voltage represents the usage state of the memory bank corresponding to the single slot voltage.

8. The method according to claim 1, wherein setting the slot voltage of the memory slot corresponding to the target pin according to the level state of the target pin comprises: synchronously adjusting the slot voltage of the memory slot corresponding to the target pin based on the level state of the target pin to enable the slot voltage of the memory slot corresponding to the target pin to be adjusted to a default state or maintained in the default state.

9. The method according to claim 8, wherein the step of setting the slot voltage of the memory slot corresponding to the target pin according to the level state of the target pin comprises at least one of:
turning on the slot voltage of the memory slot corresponding to the target pin according to the level state of the target pin to enable the memory bank; or
cutting off the slot voltage of the memory slot corresponding to the target pin according to the level state of the target pin to disable the memory bank.

10. The method according to claim 9, wherein a voltage terminal and a ground terminal are provided between the target pin and the memory slot corresponding to the target pin, wherein the voltage terminal is connected to a preset power supply through a pull-up resistor, and the ground terminal comprises a preset power supply ground wire;
the step of turning on the slot voltage of the memory slot corresponding to the target pin according to the level state of the target pin comprises:
in response to the level state of the target pin being a high level state, connecting a connection circuit between the target pin and the memory slot corresponding to the target pin to the voltage terminal to enable the connection circuit between the target pin and the memory slot corresponding to the target pin to be connected to the preset power supply and turn on the slot voltage of the memory slot corresponding to the target pin; and
the step of cutting off the slot voltage of the memory slot corresponding to the target pin according to the level state of the target pin comprises:
in response to the level state of the target pin being a low level state, connecting the connection circuit between the target pin and the memory slot corresponding to the target pin to the ground terminal to enable the connection circuit between the target pin and the memory slot corresponding to the target pin to be connected to the preset power supply ground wire and cut off the slot voltage of the memory slot corresponding to the target pin.

11. The method according to claim 1, wherein the baseboard management controller controls the memory capacity through a management page or an intelligent platform management interface instruction.

12. The method according to claim 11, wherein the baseboard management controller corresponds to the management page, wherein the management page comprises a state setting control corresponding to the memory bank or the plurality of memory slots, and the step of reading the memory setting information comprises:
responding to an setting operation for the state setting control;
determining the target protocol address value from the protocol addresses of the plurality of memory slots according to the setting operation, and determining the state setting value; and
reading the state setting value and the target protocol address value as the memory setting information.

13. The method according to claim 12, wherein
the state setting control is an enable or disable control button.

14. The method according to claim 11, wherein the step of reading the memory setting information comprises:
reading the intelligent platform management interface instruction from the baseboard management controller;
parsing a target byte of the intelligent platform management interface instruction to determine the state setting value and the target protocol address value; and
reading the state setting value and the target protocol address value as the memory setting information.

15. The method according to claim 14, wherein the method further comprises:
sending a relevant setting instruction to the baseboard management controller through an intelligent platform management interface in the case where a user needs to control remotely.

16. The method according to claim 1, wherein in the case where the target protocol address value comprises a plurality of target protocol address values, the step of determining the target pin of the expansion chip according to the target protocol address value comprises:
determining whether the target protocol address value is a last target protocol address value; and
determining the target pin of the expansion chip according to the target protocol address value, and updating the target protocol address value until the target protocol address value is the last target protocol address value in response to the target protocol address value not being the last target protocol address value.

17. The method according to claim 1, wherein the method further comprises:
performing control operation on the slot voltage of the memory slot is performed in the case where the server is shut down.

18. A server, wherein the server is provided with at least one central processing unit, each of the at least one central processing unit is provided with a plurality of memory slots, each of the plurality of memory slots is configured to install a memory bank, the plurality of memory slots are connected to a communication protocol interface of a baseboard management controller through at least one expansion chip, the plurality of memory slots and the at least one expansion chip have different protocol addresses, the plurality of memory slots are in a one-to-one correspondence with pins of each of the at least one expansion chip;
the baseboard management controller reads memory setting information, wherein the memory setting information comprises a target protocol address value and a state setting value;
the baseboard management controller determines a target pin of the expansion chip according to the target protocol address value;
the central processing unit sets a level state of the target pin according to the state setting value; and
the central processing unit sets a slot voltage of the memory slot corresponding to the target pin according to the level state of the target pin, wherein the slot voltage is configured to adjust a usage state of the memory bank.

19. (canceled)

20. An electronic device, comprising: a processor, a memory and a computer program stored in the memory and capable of running on the processor, wherein the computer program, when executed by the processor, cases the processor to implement steps of the memory capacity adjustment method according to claim 1.

21. A computer non-transitory readable storage medium storing a computer program, wherein the computer program, when executed by a processor, cases the processor to implement steps of the memory capacity adjustment method according to claim 1.
